(19) United States
(12) Patent Application Publication
(10) Pub. No.: US 2018/0072613 A1
(43) Pub. Date: Mar. 15, 2018

(54) METHOD FOR MANUFACTURING A GLASS ARTICLE AND A GLASS ARTICLE

(71) Applicant: ASAHI GLASS COMPANY, LIMITED, Chiyoda-ku (JP)

(72) Inventors: Takumi MINORIKAWA, Tokyo (JP); Tomohiro TAKANO, Tokyo (JP); Aichi INOUE, Tokyo (JP); Yusheng LANG, Tokyo (JP)

(73) Assignee: ASAHI GLASS COMPANY, LIMITED, Chiyoda-ku (JP)

(21) Appl. No.: 15/704,484

(22) Filed: Sep. 14, 2017

(30) Foreign Application Priority Data
Sep. 15, 2016 (JP) 2016-180541
Aug. 18, 2017 (JP) 2017-158181

(51) Int. Cl. C03C 15/00; C03C 21/00; C03C 17/42; C03C 17/245

(52) U.S. Cl. CPC C03C 15/00; C03C 21/002; C03C 17/42; C03C 17/245; C03C 2218/328; C03C 2217/73; C03C 2218/119; C03C 2218/154; C03C 2217/218

(57) ABSTRACT

The present invention provides a method for manufacturing a glass article in which an antifouling layer is removed easily and in a short time from the glass article on which the antifouling layer has been formed. The present invention also provides a glass article including a region having an antifouling layer and a region having no antifouling layer.

### FIELD OF THE INVENTION

The present invention relates to a method for manufacturing a glass article having an antifouling layer on its surface and a glass article.

### BACKGROUND OF THE INVENTION

A cover glass may be disposed on an outermost surface of a display with a touch panel. Since the cover glass is touched by human's fingers in use, stains such as fingerprints, sebum, sweat, etc. are apt to adhere to the cover glass. Therefore, in the cover glass, an antifouling layer with water and oil repellency is formed on a part that will be touched by human's fingers (on the operating side).

Further, an antireflection layer may be formed on the cover glass in order to improve visibility of an image displayed on the display.

Some applications of a cover glass require attaching a member to the outermost surface of the cover glass. For example, in a cover glass for a cluster, it is necessary to attach a member such as a speedometer to a surface which may be touched by human's fingers in use. On this occasion, when the member is attached onto the antifouling layer in the outermost surface of the cover glass, satisfactory adhesiveness cannot be secured. Thus, the member cannot be attached or may be detached easily. It is therefore desired that the antifouling layer is not formed in a region on the cover glass to which the member will be attached.

In addition, the antireflection layer may or may not be formed in the region to which the member will be attached.

According to a method in which an antifouling layer is not formed in a region on a cover glass to which a member should be attached, the region on the cover glass to which the member should be attached is masked to prevent the antifouling layer from adhering to the region when the antifouling layer is formed. However, it is difficult to secure the position accuracy of masking, and the steps of the method are also complicated. It is therefore desired to remove the antifouling layer from an unnecessary part after the antifouling layer is formed.

Patent Document 1 discloses that a target member on which an antifouling layer has been formed is disposed in a steam atmosphere having a relative humidity of 50% or higher, and the antifouling layer is irradiated with vacuum ultraviolet light in this state so that the antifouling layer can be removed.

However, according to the aforementioned method, in order to remove the antifouling layer, it is necessary to use a mask having openings corresponding in size and shape to regions from which the antifouling layer should be removed. The method thus has a step of aligning the mask with glass, and time for that is thus required. In addition, in the step of removing the antifouling layer, it is necessary to control the relative humidity. Thus, there is a problem that the process is complicated. Further, the output power of the vacuum ultraviolet light is small. Thus, there is another problem that it takes much time to remove the antifouling layer.

### [Patent Document 1] JP-A-2014-100634

### SUMMARY OF THE INVENTION

The present invention has been developed in order to solve the foregoing problems. An object of the invention is to provide a method for manufacturing a glass article in which an antifouling layer is removed easily and in a short time from the glass article on which the antifouling layer has been formed.

Another object of the invention is to provide a glass article including a region having an antifouling layer and a region having no antifouling layer.

Namely, the present invention relates to the following items [1] to [14].

[1] A method for manufacturing a glass article, the glass article including: a glass plate having a first main surface and a second main surface opposed to each other, and an antifouling layer formed on the first main surface, the method including irradiating the glass article with a laser beam from the first main surface side, thereby selectively removing the antifouling layer.
[2] The method for manufacturing a glass article according to [1], in which a laser device for oscillating the laser beam is a CO₂ laser device, YVO₄ laser device or a YAG laser device.
[3] The method for manufacturing a glass article according to [1] or [2], in which output power of the laser device is 1 to 1,000 W.
[4] The method for manufacturing a glass article according to any one of [1] to [3], in which an antireflection layer is further formed between the first main surface of the glass plate and the antifouling layer.
[5] A method for manufacturing a glass article having a member, the glass article including: a glass plate having a first main surface and a second main surface opposed to each other, and an antifouling layer formed on the first main surface, the method including: irradiating the glass article with a laser beam from the first main surface side, thereby selectively removing the antifouling layer, followed by bonding the member to a region from which the antifouling layer has been removed.
[6] The method for manufacturing a glass article having a member according to [5], in which an antireflection layer is further formed between the first main surface of the glass plate and the antifouling layer.
[7] The method for manufacturing a glass article having a member according to [5] or [6], in which the member comprises at least one of a resin, a metal and a rubber.
[8] A glass article including a glass plate that having a first main surface and a second main surface opposed to each other; in which an antifouling portion which is formed on the first main surface and comprises an antifouling layer and an opening portion which is formed on the first main surface, has no antifouling layer and has fine concave convex shapes.
[9] The glass article according to [8], in which a surface roughness Ra in the opening portion is 5 nm or higher.
[10] The glass article according to [8] or [9], in which a ten-point average roughness Rz in the opening portion is 17 nm or higher.
[11] The glass article according to any one of [8] to [10], in which Kα characteristic X-ray intensity derived from a fluorine (F) element obtained by X-ray fluorescence analysis is 0.15 kcps or lower.
[12] The glass article according to any one of [8] to [11], in which a printed layer is provided on a peripheral edge portion of the second main surface of the glass plate; and the opening portion is formed on the first main surface within a region corresponding to a region on the second main surface where the printed layer is present.
[13] The glass article according to any one of [8] to [12], in which an antireflection layer is provided between the first main surface of the glass plate and the antifouling layer in the antifouling portion.
[14] The glass article according to any one of [8] to [13], in which a water contact angle of the opening portion is 105° or lower.

According to the manufacturing method of the invention, a glass article on which an antifouling layer has been formed can be manufactured easily and in a short time.

The glass article according to the invention includes a region having an antifouling layer and a region having no antifouling layer, and a surface roughness in the region having no antifouling layer is within a predetermined range so that a member can be firmly attached to the region having no antifouling layer.

### BRIEF DESCRIPTION OF THE DRAWINGS

FIGS. 1A, 1B and 1C are views for explaining a method for manufacturing a glass article according to the first embodiment of the invention.

FIGS. 2A, 2B, 2C and 2D are views for explaining a method for manufacturing a glass article according to the second embodiment of the invention.

FIGS. 3A and 3B are views for explaining a method for attaching a member to the glass article according to the first embodiment of the invention.

FIGS. 4A and 4B are views for explaining a method for attaching a member to the glass article according to the second embodiment of the invention.

FIG. 5 is a schematic sectional view of the glass article having an opening portion of the present invention.

### DETAILED DESCRIPTION OF THE INVENTION

Embodiments of the invention will be described below in detail with reference to the drawings.

### First Embodiment

The first embodiment of the invention provides a method for manufacturing a glass article, the glass article includes a glass plate having a first main surface and a second main surface opposed to each other and an antifouling layer formed on the first main surface of the glass plate, and the method includes irradiating the glass article with a laser beam from the first main surface side of the glass plate thereby selectively remove the antifouling layer.

In the present description, the “glass article” means a glass article including a glass plate having a first main surface and a second main surface opposed to each other and an antifouling layer formed on the first main surface of the glass plate, unless otherwise noted.

### Second Embodiment

The second embodiment of the invention provides a method for manufacturing a glass article in which the glass article includes a glass plate having a first main surface and a second main surface opposed to each other, and an antireflection layer and an antifouling layer formed on the first main surface of the glass plate, the method includes irradiating the glass article with a laser beam from the first main surface side of the glass article thereby to selectively remove at least one of the antireflection layer and the antifouling layer.

### [Method for Manufacturing Glass Article]

### First Embodiment

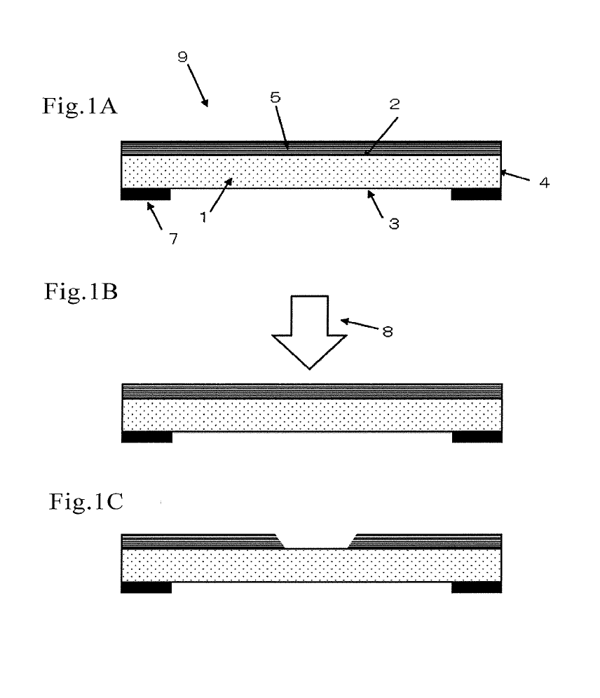

FIGS. 1A, 1B and 1C are views for explaining a method for manufacturing a glass article according to the first embodiment of the invention. Specifically, FIGS. 1A, 1B and 1C are views for explaining a method for removing an antifouling layer 5 from a surface of a glass article.

FIG. 1A is a sectional view of a glass article 9, in which a glass plate 1 has a first main surface 2 and a second main surface 3 as described above, and the antifouling layer 5 is formed on the first main surface 2. The first main surface 2 and the second main surface 3 of the glass plate 1 are opposed to each other.

FIG. 1B is a view for explaining a method for processing the glass article 9 by laser beam 8. Specifically FIG. 1B is a view for explaining a step of removing the antifouling layer 5.

Further, FIG. 1C is an explanatory view showing a section of the glass article from which the antifouling layer 5 has been selectively removed.

### Second Embodiment

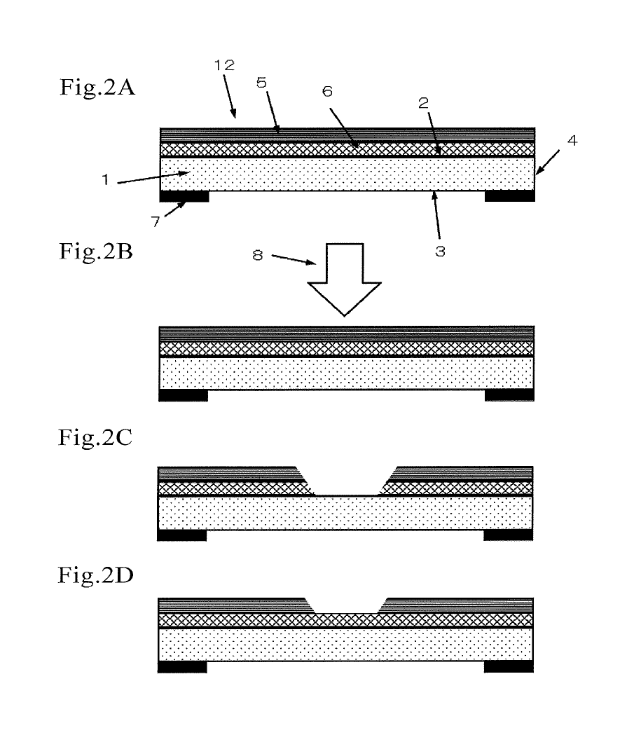

FIGS. 2A, 2B, 2C and 2D are views for explaining a method for manufacturing a glass article according to the second embodiment of the invention. Specifically, FIGS. 2A, 2B, 2C and 2D are views for explaining a method for removing at least one of an antireflection layer 6 and an antifouling layer 5 from a surface of a glass article.

FIG. 2A is a sectional view of a glass article 9, in which a glass plate 1 has a first main surface 2 and a second main surface 3 as described above, and the antireflection layer 6 and the antifouling layer 5 are formed on the first main surface 2. The first main surface 2 and the second main surface 3 of the glass plate 1 are opposed to each other.

FIG. 2B is a view for explaining a method for processing the glass article 9 by laser beam 8. Specifically FIG. 2B is a view for explaining a step of removing at least one of the antireflection layer 6 and the antifouling layer 5.

Further, FIG. 2C is an explanatory view showing a section of the glass article from which the antireflection layer 6 and the antifouling layer 5 have been selectively removed, and FIG. 2D is an explanatory view showing a section of the glass article from which only the antifouling layer 5 has been selectively removed.

### [Method for Removing Antireflection Layer and Antifouling Layer]

In order to remove the antifouling layer 5 or at least one of the antireflection layer 6 and the antifouling layer 5, the first main surface 2 of the glass article 9 is irradiated with the laser beam 8.

A laser of CO₂, YAG and YVO₄ etc. may be used as a laser for radiating the laser beam 8, namely, laser devices oscillating these laser beams may be used. It is well known that a coating agent adhered to metal is removed by using a YAG laser. However, when a glass plate is a base material, the wavelength of the YAG laser is transmitted through the glass plate. In terms of efficiency, it is therefore preferable to use a CO₂ laser which is capable of absorbing the laser beam in a glass interface. On the other hand, in terms of reduction in damage to a glass plate, YAG laser is preferable.

The output power of the laser device is preferably 1 to 1,000 W, more preferably 5 to 500 W, still more preferably 10 to 500 W, and even more preferably 50 to 200 W. When the output power is 1 W or higher, a spot diameter can be increased. This is preferred in terms of work efficiency. When the output power is 1,000 W or lower, the temperature of the glass plate can be prevented from reaching a high temperature. This is preferable in terms of prevention of influence on the antireflection layer 6 or the antifouling layer 5 on the glass plate or on printing on the glass plate.

It is noted that the spot diameter is selected in accordance with the regions from which the antireflection layer 6 or the antifouling layer 5 should be removed.

Either a CW laser or a pulse laser may be selected as the laser.

Each of the regions from which the antireflection layer 6 and/or the antifouling layer 5 should be removed by the laser beam may be located either in an inner portion (entirely surrounded by the antireflection layer 6 or the antifouling layer 5) on the glass plate or in a peripheral portion thereof. The number of the regions from which the antireflection layer 6 and/or the antifouling layer 5 should be removed may be either one or plural. The shape of each region from which the antireflection layer 6 and/or the antifouling layer 5 should be removed may be linear, quadrangular, triangular, circular, or the like. Each region from which the antireflection layer 6 and/or the antifouling layer 5 should be removed, the place of the region, and the shape of the region may be selected desirably in accordance with the shape of a member to be attached.

### [Method for Attaching Member to Glass Article]

### First Embodiment

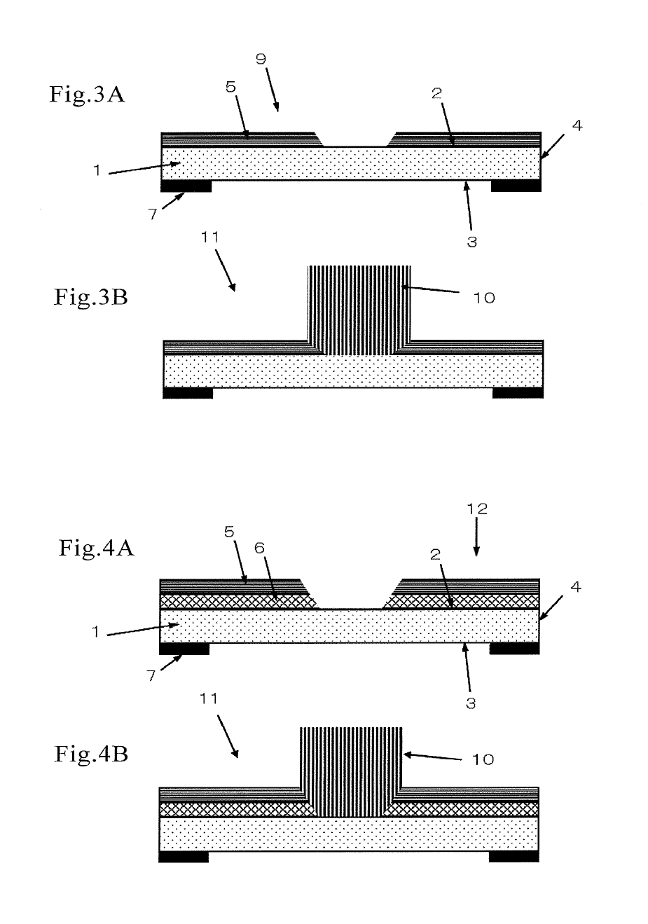

FIGS. 3A and 3B are views for explaining a method for attaching a member to a glass article according to the first embodiment of the invention.

FIG. 3A is a view showing a section of the glass article from which the antifouling layer 5 has been removed.

FIG. 3B is an explanatory view showing a section of the glass article in which the member has been attached to a region from which the antifouling layer 5 has been removed.

### Second Embodiment

FIGS. 4A and 4B are views for explaining a method for attaching a member to a glass article according to the second embodiment of the invention.

FIG. 4A is a view showing a section of the glass article from which the antireflection layer 6 and the antifouling layer 5 have been removed.

FIG. 4B is an explanatory view showing a section of the glass article in which the member has been attached to a region from which the antireflection layer 6 and the antifouling layer 5 have been removed.

### (Method for Attaching Member to Glass Article)

The methods for attaching a member to a glass article include a method using an adhesive such as epoxy-based one, cyanoacrylate-based one, thermosetting-resin, or elastomer-based one. The bonding agent is not specified as long as it can bond the glass article and the member with each other and it is superior in durability.

### (Member)

Examples of the member to be attached to the glass article include frames for push buttons, switches, dials, meters, etc., decorating materials such as logos, and marks, etc. Examples of the material of the member include resin materials, metal materials, and rubber materials.

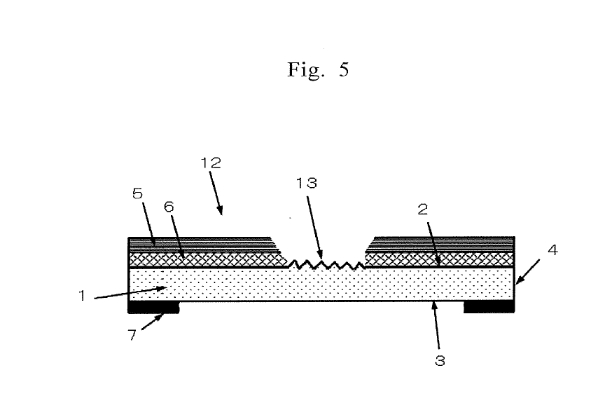

Next, configurations of constituents in the glass article 12 according to the invention will be described with reference to FIG. 5. The glass article 12 according to the invention includes, on the first main surface 2 of the glass plate 1, an antifouling portion including the antifouling layer 5 and an opening portion 13 which has no antifouling layer 5 but has fine concave convex shapes (which will be also simply referred to as opening portion 13 in the following description). Incidentally, although the glass article 12 according to the invention is described below, all the description except the opening portion 13 can be also applied to the glass article 9. Any glass article may be interpreted as either the glass article 9 or the glass article 12 unless otherwise described.

(Glass Plate 1)

In the glass plate 1 contained in a glass article, the shape of the glass plate 1 is not particularly limited as long as the glass plate has a first main surface 2, a second main surface 3, and end surfaces 4. For example, the first main surface 2 of the glass plate 1 may have a quadrangular shape, as well as a circular shape or an elliptic shape or the like, or may be formed into a desired shape in accordance with its purpose. In addition, the shape may be two-dimensional or three-dimensional.

For the glass plate 1 for use in the invention, a glass plate 1 made of general glass having silicon dioxide as its main component, such as soda lime silicate glass, aluminosilicate glass, borosilicate glass, alkali-free glass, quartz glass, etc. may be used.

Preferably the glass of the glass plate 1 has a composition capable of being molded and strengthened by chemically strengthening treatment, and the glass preferably includes sodium. Specifically, as such glass, aluminosilicate glass, soda lime silicate glass, borosilicate glass, lead glass, alkali-barium glass, aluminoborosilicate glass, etc. may be preferably used.

A method for producing the glass plate 1 is not particularly limited. The glass plate 1 may be produced as follows. That is, a desired glass raw material is put into a continuous melting furnace, and the glass raw material is heated and melted preferably at 1,500 to 1,650° C., and clarified. After that, the molten glass is supplied into a forming apparatus, molded into a plate-like shape, and gradually cooled.

A method for molding the glass plate 1 is not particularly limited, either. Examples of the method includes a down-draw process (such as an overflow down-draw process, a slot down-draw process, a redraw process, etc.), a float process, a roll-out process, a press process, etc.

The thickness of the glass plate 1 may be selected suitably in accordance with its applications. The thickness of the glass plate 1 is preferably 0.1 to 5 mm, more preferably 0.2 to 2 mm, further more preferably 0.5 to 2 mm. When the thickness of the glass plate 1 is 5 mm or lower, the chemically strengthening treatment which will be described later can be effectively performed on the glass plate 1 to achieve both reduction in weight and enhancement in strength.

(Antifouling Layer)

The antifouling layer 5 has water repellency or oil repellency to provide an antifouling property. The material of the antifouling layer 5 is not particularly limited as long as it can give an antifouling property to the glass plate 1. The antifouling layer 5 is preferably made of a coating of a fluorine-containing organic silicon compound obtained by curing the fluorine-containing organic silicon compound. In the present description, a hydrolyzable fluorine-containing silicon compound means a compound which contains a hydrolyzable silyl group having a hydrolyzable group or atom bonded to a silicon atom, and which further contains a fluorine-containing organic group bonded to the silicon atom. The hydrolyzable group or atom bonded to the silicon atom to thereby form the hydrolyzable silyl group will be referred to as “hydrolyzable group” in any case.

A composition for forming the coating is a composition containing the hydrolyzable fluorine-containing silicon compound. Specifically, KP-801 (trade name, made by Shin-Etsu Chemical Co., Ltd.), X-71 (trade name, made by Shin-Etsu Chemical Co., Ltd.), KY-130 (trade name, made by Shin-Etsu Chemical Co., Ltd.), KY-178 (trade name, made by Shin-Etsu Chemical Co., Ltd.), KY-185 (trade name, made by Shin-Etsu Chemical Co., Ltd.), Optool® DSX (trade name, made by Daikin Industries, Ltd.), etc. may be preferably used.

The coating forming composition containing such a hydrolyzable fluorine-containing silicon compound is applied onto a surface of the antireflection layer 6 to react and thereby formed into a film. Thus, the fluorine-containing organic silicon compound coating can be obtained.

The antifouling layer 5 is formed on the surface of the antireflection layer 6. The thickness of the antifouling layer 5 is not particularly limited. The film thickness of the antifouling layer 5 on the first main surface 2 is preferably 2 to 20 nm, more preferably 2 to 15 nm, further more preferably 2 to 10 nm. When the film thickness of the antifouling layer 5 on the first main surface 2 is 2 nm or higher, the first main surface 2 of the glass plate 1 can be covered with the antifouling layer 5 uniformly enough to withstand practical use in terms of friction resistance. On the other hand, when the film thickness of the antifouling layer 5 on the first main surface 2 is 20 nm or lower, an optical property such as a haze value of the antireflection layer on which the antifouling layer is formed or the glass plate 1 with the antifouling layer thereon is superior.

### (Method for Forming Antifouling Layer 5)

Examples of the method for forming the antifouling layer 5 may include a wet method such as a spin coat method, a dip coat method, a cast method, a slit coat method or a spray coat method, or a vapor deposition method, etc. In order to obtain a coating with high adhesiveness to the antireflection layer 6, it is preferable to form the antifouling layer 5 by a vacuum vapor deposition method.

(Antireflection Layer)

The antireflection layer 6 is formed of an antireflection layer forming material. The antireflection layer 6 is formed between the antifouling layer 5 and the glass plate 1. The antireflection layer 6 may be constituted by a single layer, or may contain a multilayer structure constituted by a plurality of layers.

The antireflection layer 6 is formed by laminating a high refractive index layer and a low refractive index layer between the first main surface 2 and the antifouling layer 5. A configuration of the antireflection layer 6 is not particularly limited as long as reflection of light can be suppressed by the configuration. For example, the configuration may be a lamination in which a high refractive index layer having a refractive index of 1.9 or higher at a wavelength of 550 nm and a low refractive index layer having a refractive index of 1.6 or lower at the wavelength of 550 nm are laminated. The antireflection layer 6 may be formed to include a single high refractive index layer and a single low refractive index layer. Alternatively, the antireflection layer 6 may be configured to include two or more high refractive index layers and two or more low refractive index layers. When the antireflection layer 6 includes two or more high refractive index layers and two or more low refractive index layers, it is preferable that the antireflection layer 6 has a form in which the high refractive index layers and the low refractive index layers are laminated alternately.

The materials of the high refractive index layer and the low refractive index layer are not particularly limited, and may be selected suitably in consideration of a required degree of low reflectivity, required productivity, and so on. Regarding the material forming the high refractive index layer, at least one kind selected from niobium oxide (Nb₂O₅), titanium oxide (TiO₂), zirconium oxide (ZrO₂), tantalum oxide (Ta₂O₅) and silicon nitride (SiN) may be preferably used. Regarding the material forming the low refractive index layer, at least one kind selected from silicon oxide (SiO₂), a material containing a composite oxide of Si and Sn, a material containing a composite oxide of Si and Zr, and a material containing a composite oxide of Si and Al may be preferably used.

In terms of productivity and refractive indexes, it is preferable that the high refractive index layer contains one kind selected from niobium oxide, titanium oxide and silicon nitride, and the low refractive index layer containing silicon oxide.

### (Method for Forming Antireflection Layer 6)

A method for forming the antireflection layer 6 is not particularly limited, and various film forming methods may be used. For example, a vacuum vapor deposition method, an ion beam assist vapor deposition method, an ion plate method, a sputtering method, a plasma CVD method, etc. may be used. Of those film forming methods, it is preferable to use the sputtering method because a compact film with high durability can be formed. Particularly, it is preferable that the film is formed by a sputtering method such as a pulse sputtering method, an AC sputtering method or a digital sputtering method.

For example, when a film is formed by the pulse sputtering method, the glass plate is placed in a chamber with a mixed gas atmosphere of inactive gas and oxygen gas, and the film is formed with a target selected to have a desired composition. On this occasion, the inactive gas in the chamber is not limited to any specific gas types, but various inactive gases such as argon, helium, etc. may be used.

Pressure of the mixed gas including the inert gas and the oxygen gas inside the chamber is not particularly limited. When the pressure is set within a range of 0.5 Pa or lower, the surface roughness of the formed film can be easily set within a preferable range. A lower limit value of the pressure of the mixed gas including the inert gas and the oxygen gas inside the chamber is not particularly limited, and it is preferably 0.1 Pa or higher.

(Antiglare Treatment)

It is preferable that the first main surface 2 of the glass plate 1 for use in the embodiment has concave convex shapes for giving an antiglare property to the glass plate 1, though not shown in FIG. 5.

For the method for forming the concave convex shapes, known methods may be used. The method is not particularly limited as long as the method can form concave convex shapes capable of providing an antiglare property. For example, to the first main surface 2 of the glass plate 1, surface treatment is performed by applying a chemical method or a physical method so that concave convex shapes with desired surface roughness can be formed.

Examples of the antiglare treatment using a chemical method include a method performing a frosting treatment. The frosting treatment is performed by, for example, immersing the glass plate 1 as a body to be treated in a mixed solution of hydrogen fluoride and ammonium fluoride.

On the other hand, the antiglare treatment using a physical method may be performed by, for example, so-called sand blasting treatment in which crystalline silicon dioxide powder, silicon carbide powder, or the like is blasted onto the surface of the glass plate 1 by pressurized air, or a method in which crystalline silicon dioxide powder, silicon carbide powder, or the like is attached to a brush, and the brush is wetted with water and used for polishing the surface of the glass plate 1.

Of those, the frosting treatment which is a chemical surface treatment hardly generates a micro-crack which may serve as an origin of cracking in the surface of a body to be treated, so that the strength of the glass plate 1 can be prevented from deteriorating. Therefore, the frosting treatment may be preferably used.

Further, it is preferable that etching treatment is performed on the first main surface 2 of the glass plate 1 subjected to the antiglare treatment, so that the surface shape of the first main surface 2 can be set. For the etching treatment, for example, a chemical etching method in which the glass plate 1 is immersed in an etching solution of hydrogen fluoride may be used. The etching solution may contain acid such as hydrochloric acid, nitric acid or citric acid in addition to the hydrogen fluoride. When the etching solution contains such an acid, it is possible to suppress local generation of a precipitation caused by reaction between cations such as Na ions or K ions contained in the glass plate 1 and the hydrogen fluoride. It is also possible that etching proceeds uniformly within the surface to be treated.

When the etching treatment is performed, the concentration of the etching solution, the time for which the glass plate 5 is immersed in the etching solution, etc. are adjusted to control the etching amount, so that the haze value of the antiglare-treated surface of the glass plate 1 can be set into a desired value. In addition, when the antiglare treatment is performed by physical surface treatment such as sand blasting treatment, cracks may be generated, but such cracks can be removed by the etching treatment. In addition, by the etching treatment, an effect of suppressing glare of the glass plate 1 with the antifouling layer can be also obtained.

(Chemically Strengthening Treatment)

In order to enhance the strength of the glass plate 1, it is preferable to perform chemically strengthening treatment on the glass plate 1. It is preferable that the chemically strengthening treatment is performed after the glass plate 1 is cut into a desired size in accordance with necessity.

The chemically strengthening treatment is not particularly limited. The first main surface 2, the second main surface 3 and end surfaces 4 of the glass plate are subjected to ion exchange to form a surface layer where compressive stress remains. Specifically, at a temperature not higher than a glass transition temperature of the glass, alkali metal ions (such as Li ions or Na ions) contained in the glass in the surface of the glass plate 1 and each having a small ion radius are replaced by alkali metal ions each having a larger ion radius (such as Na ions or K ions for Li ions, or K ions for Na ions). In this manner, the compressive stress can remain in the main surface of the glass plate 1 and the strength of the glass plate 1 is thus improved.

(Printing Layer 7)

A printing layer 7 may be formed in the glass article 12 of the embodiment. The printing layer 7 is formed on a peripheral edge portion of the second main surface 3. The printing layer 7 is provided, for example, to cover a wiring circuit disposed near the outer circumference of a display unit of a portable device, a bonding portion of the glass plate 1 with the antifouling layer and an adhesion layer to a housing of the portable device, etc. in order to improve visibility and appearance of the display. Here, the peripheral edge portion means a belt-like region having a predetermined width and extending from the outer circumference toward a central portion. The printing layer 7 may be provided all over the circumference of the peripheral edge of the second main surface 3, or may be provided in a part of the peripheral edge.

The printing layer 7 is formed by printing with ink. The ink is not particularly limited, and may be selected in accordance with color of the printing layer 7 to be formed. For example, either an inorganic ink containing ceramic sintered pieces or the like or an organic ink containing colorant such as dye or pigment and organic resin may be used as the ink. Examples of a method of printing with ink may include a bar coat method, a reverse coat method, a gravure coat method, a die coat method, a roll coat method, a screen method, etc. The screen printing method is preferable because it can print simply and easily on various base materials and in accordance with the size of the glass plate 1. The printing layer 7 may be a composite layer in which a plurality of layers are laminated, or may be a single layer. When the printing layer 7 is made of a composite layer, the printing layer 7 can be formed by repeating the aforementioned printing in ink and drying.

The glass article 12 according to the embodiment has the opening portion 13 which does not have the antifouling layer 5, but has fine concave convex shapes on the first main surface 2 of the glass plate 1. It is preferable that the opening portion 13 is formed by a processing method of the glass article 12 according to the invention. That the opening portion 13 in the first main surface 2 of the glass article 12 does not have the antifouling layer 5 means that a layer formed of the same material with the same thickness as a portion other than the opening portion 13 is absent from the opening portion 13. Accordingly, a thinner layer than a portion other than the opening portion 13 may be formed in the opening portion 13 of the material forming the antifouling layer 5, or the material forming the antifouling layer 5 may be present in a degenerated form in the opening portion 13. Further, when the material forming the antifouling layer 5 is present in a degenerated form in the opening portion 13, the form does not have to be a layered form, and may be a dotted form where dots of the material are scattered on the first main surface 2 of the glass plate 1.

Surface roughness Ra of the fine concave convex shapes of the opening portion 13 is preferably 5 nm or higher. When the surface roughness Ra is within the aforementioned range, it is possible to enhance the adhesive force with which a member can be attached to the opening portion 13.

The surface roughness Ra is calculated in the following manner.

The first main surface 2 of the glass article 12 including the opening portion 13 is sectionally cut and mirror-polished, and an SEM image (scanning electron microscope image) of a section in the opening portion 13 is obtained. From the SEM image, the thickness of the antireflection layer 6 is measured at an interval of 20 nm over a reference length of 2,500 nm in a surface direction of the glass article 12 perpendicular to the sectionally cut direction to obtain a thickness distribution in the antireflection layer. The thickness distribution in the antireflection layer 6 is much finer than that in the concave convex shapes obtained by the aforementioned antiglare treatment. Therefore, the thickness distribution can be evaluated as a reference of surface roughness. A difference from an average value of the antireflection layer thickness is used as a function (f(X)) for a distance X in the surface direction of the glass article 12 to calculate the surface roughness Ra from the following expression according to JIS B 0601-2013.

$$Ra = \frac{1}{L} {\int }_{0}^{L} \vert f ( X ) \vert dX$$

Here, L designates a reference length, which is 2,500 nm.

The surface roughness Ra is preferably 5 nm or higher, and more preferably 10 nm or higher. When the surface roughness Ra is increased, it is possible to enhance the adhesive force with which a member can be attached to the opening portion 13. On the other hand, the surface roughness Ra is preferably 50 nm or lower, more preferably 40 nm or lower, and even more preferably 20 nm or lower. When the surface roughness Ra is decreased, the opening portion 13 can be made less conspicuous due to the fine concave convex shapes. Thus, the opening portion 13 can be improved in appearance design.

Ten-point average roughness (maximum height) Rz of the fine concave convex shapes of the opening portion 13 is preferably 17 nm or higher. When the ten-point average roughness (maximum height) Rz is within the aforementioned range, it is possible to enhance the adhesive force with which a member can be attached to the opening portion 13.

The ten-point average roughness (maximum height) Rz is calculated as follows.

The first main surface 2 of the glass article 12 including the opening portion 13 is sectionally cut and mirror-polished, and an SEM image (scanning electron microscope image) of a section in the opening portion 13 is obtained. From the SEM image, the thickness of the antireflection layer 6 is measured at an interval of 20 nm over a reference length of 2,500 nm in the surface direction of the glass article 12 perpendicular to sectionally cut direction to obtain a thickness distribution of the antireflection layer. The thickness distribution of the antireflection layer 6 is much finer than that of the concave convex shapes obtained by the aforementioned antiglare treatment. Therefore, the thickness distribution can be evaluated as a reference of surface roughness. Of differential values from an obtained average value of the antireflection layer thickness, thicknesses in five highest points (Yp1, Yp2, Yp3, Yp4 and Yp5) and five lowest points (Yv1, Yv2, Yv3, Yv4 and Yv5) are used to calculate the ten-point average roughness Rz from the following expression according to JIS B 0601-2013.

$$Rz = \frac{\vert Yp 1 + Yp 2 + Yp 3 + Yp 4 + Yp 5 \vert + \vert Yv 1 + Yv 2 + Yv 3 + Yv 4 + Yv 5 \vert}{5}$$

The ten-point average roughness (maximum height) Rz is more preferably 17 nm or higher, and more preferably 50 nm or higher. When the ten-point average surface roughness (maximum height) Rz is increased, it is possible to enhance the adhesive force with which a member can be attached to the opening portion 13. On the other hand, the ten-point average surface roughness (maximum height) Rz is preferably 300 nm or lower, more preferably 250 nm or lower, and even more preferably 200 nm or lower. When the ten-point average surface roughness (maximum height) Rz is decreased, the opening portion 13 can be made less conspicuous due to the fine concave convex shapes. Thus, the opening portion 13 can be improved in appearance design.

It is preferable that the concentration of fluorine (F) atoms in the opening portion 13 is low. When the concentration of fluorine atoms is decreased, it is possible to enhance the adhesive force with which a member can be attached to the opening portion 13. The concentration of fluorine atoms in the opening portion 13 is proportional to the intensity of characteristic X-rays derived from an F element and obtained by an X-ray fluorescence analyzer (XRF). In the embodiment, the concentration of fluorine atoms is expressed by a value of intensity of a Ku ray derived from a fluorine element and obtained by a method which will be described in detail in Examples.

In order to enhance the adhesive force with which a member can be attached to the opening portion 13, the Kα characteristic X-ray intensity derived from the fluorine (F) element obtained by X-ray fluorescence analysis is preferably 0.15 kcps or lower, and more preferably 0.05 kcp or lower. On the other hand, in order to secure the adhesive force with which a member can be attached to the opening portion 13, the Ku characteristic X-ray intensity derived from the fluorine (F) element may be 0.01 kcps or higher. It is especially preferable that the Kα characteristic X-ray intensity derived from the fluorine (F) element is 0 (zero) in the opening portion 13.

The adhesive force with which a member can be attached to the opening portion 13 can be evaluated by a method which will be described in Examples.

The front shape of the opening portion 13, that is, the shape viewed from the surface side where the antifouling layer 5 is present in the glass article 12 may be designed variously. For example, the front shape may be rectangular or circular and its dimensions (area) may be changed desirably. When a member is attached to the opening portion 13, it is preferable that the shape of the opening portion 13 is designed in accordance with the dimensions or shape of the member.

In addition, the opening portion may be formed at any place within the first main surface. In particular, it is preferable that the opening portion is present on the first main surface within a region where the aforementioned printed layer is present on the second main surface opposed to the first main surface. This is because a member is often attached to such a region and it is possible to secure a satisfactory design property in the glass article with the member.

The water contact angle of the opening portion 13 is preferably 1050 or lower. When the water contact angle is 105° or lower, it is possible to enhance the adhesive force with which a member can be attached to the opening portion 13. In the embodiment, the water contact angle is a value measured by a method which will be described in Examples.

The water contact angle is more preferably 103° or lower, and even more preferably 100° or lower. On the other hand, the lower limit of the water contact angle is not particularly limited, and it may be set preferably at 5° or higher, and more preferably at 100 or higher.

### EXAMPLES

Next, examples of the invention will be described. The invention is not limited to the following examples. Examples 1 to 4 and Example 7 are working examples of the invention, and Examples 5 and 6 are comparative examples. In addition, examples 8 to 10 are working examples of the invention.

Plate-like glasses (Dragontrail®, made by Asahi Glass Co., Ltd.) having opposed quadrangular main surfaces each having a thickness of 1.3 mm were used for glass plates, and the glass plates each having an antifouling layer were obtained with the following procedures of Examples respectively. In the following description, one main surface of each of the glass plates will be referred to as a first main surface, the other surface will be referred to as a second main surface, and each surface in the thickness direction will be referred to as an end surface.

### Example 1

(1) Antiglare treatment, (2) chamfering, (3) chemically strengthening treatment and alkali treatment, (4) formation of a printing layer, (5) formation of an antireflection layer, (6) film formation of an antifouling layer, (7) removal of the antireflection layer and the antifouling layer by a laser, and (8) attachment of a member were performed on each glass plate in this order by the following procedures.

### (1) Antiglare Treatment

Antiglare treatment using frosting treatment was performed on the first main surface of the glass plate by the following procedure.

First, an acid-resistant protective film (hereinafter also simply referred to as “protective film”) was attached on a main surface (second main surface) of the glass plate where antiglare treatment will not be performed. Next, the glass plate was immersed for 3 minutes in a solution of 3 mass % hydrogen fluoride and then etched, so as to remove dirt adhering to the first main surface of the glass plate. Next, the glass plate was immersed for 3 minutes in a mixed solution of 15 mass % hydrogen fluoride and 15 mass % potassium fluoride, so as to perform frosting treatment on the first main surface of the glass plate. After that, the glass plate was immersed for 6 minutes in a solution of 10 mass % hydrogen fluoride. Thus, the haze value of the first main surface subjected to the antiglare treatment was adjusted to 25%. The haze value was measured according to JIS K 7136 by using a haze meter (trade name: HZ-V3, made by Suga Test Instruments Co., Ltd.).

### (2) Chamfering

The glass plate subjected to the antiglare treatment was cut into 150 mm by 250 mm in size. After that, C-chamfering was performed all over the circumference of the glass plate by 0.2 mm. The chamfering was performed using a grindstone #600 (made by Tokyo Diamond Tools Mfg. Co., Ltd.?) at a grindstone rotational frequency of 6,500 rpm and at a grindstone moving speed of 5,000 mm/min.

### (3) Chemically Strengthening Treatment and Alkali Treatment

The aforementioned protective film attached on the second main surface of the glass plate was removed, and the glass plate was immersed for 2 hours in molten salt of potassium nitrate heated to 450° C. After that, the glass plate was pulled out from the molten salt, and gradually cooled down to a room temperature for 1 hour. Thus, chemically strengthening treatment was performed. As a result, a chemically strengthened glass plate having a surface compressive stress (CS) of 730 MPa and a depth of stress layer (DOL) of 30 μm was obtained. Further, the glass plate was immersed in an alkali solution (SUNWASH TL-75, made by Lion Corporation) for 4 hours to perform alkali treatment.

### (4) Formation of Printing Layer

A black frame with a width of 2 cm was printed on four sides of an outside peripheral side portion of the second main surface of the glass plate to form a printing layer. First, black ink (trade name: GLSHF, made by Teikoku Printing Inks Mfg. Co., Ltd.) was applied to be 5 μm thick by a screen printer, and then kept at 150° C. for 10 minutes to dry. The first printing layer was thus formed. Next, in the same procedure as described above, the black ink was applied onto the first printing layer so as to reach a thickness of 5 μm, and then kept at 150° C. for 40 minutes to dry. The second printing layer was thus formed. In this manner, a printing layer in which the first printing layer and the second printing layer had been laminated was formed. Thus, a glass plate in which the printing layer had been provided in the outer peripheral portion of the second main surface of the glass plate was obtained.

### (5) Formation of an Antireflection Layer

Next, a high refractive index layer was formed on the first main surface of the glass plate to which the antiglare treatment was performed as follows. While mixed gas in which oxygen gas of 10 vol % had been mixed into argon gas was introduced into a vacuum chamber, pulse sputtering was performed using a niobium oxide target (trade name: NBO target (made by AGC Ceramics CO., Ltd.)) under conditions of a pressure of 0.3 Pa, a frequency of 20 kHz, an electric power density of 3.8 W/cm², and an inversion pulse width of 5 μsec. Thus, the first high refractive index layer made of niobium oxide (niobia) with a thickness of 13 nm on the first main surface of the glass plate was formed on the first main surface of the glass plate.

Next, while mixed gas in which oxygen gas of 40 vol % had been mixed into argon gas was introduced, pulse sputtering was performed using a silicon target under conditions of a pressure of 0.3 Pa, a frequency of 20 kHz, an electric power density of 3.8 W/cm², and an inversion pulse width of 5 μsec. Thus, the first low refractive index layer made of silicon oxide (silica) with a thickness of 35 nm on the first main surface of the glass plate was formed on the aforementioned high refractive index layer.

Next, in the same manner as the first high refractive index layer, the second high refractive index layer made of niobium oxide (niobia) with a thickness of 115 nm on the first main surface of the glass plate was formed on the first low refractive index surface. Further, in the same manner as the first low refractive index layer, the second low refractive index layer made of silicon oxide (silica) with a thickness of 80 nm on the first main surface of the glass plate was formed on the second high refractive index surface.

In this manner, a low reflection film in which a total of four layers of niobium oxide (niobia) and silicon oxide (silica) were laminated alternately was formed.

### (6) Film Formation of Antifouling Layer

First, as a material of an antifouling layer, a formation material (KY-185, made by Shin-Etsu Chemical Co., Ltd.) of a fluorine-containing organic silicon compound film was introduced into a heating vessel. After that, the heating vessel was degassed for at least 10 hours by a vacuum pump to thereby remove a solvent from a solution. Thus, a composition for forming a fluorine-containing organic silicon compound film (hereinafter referred to as antifouling layer formation composition) was obtained in the heating vessel. The glass plate was used while it had been attached to a carrier substrate, and an antifouling layer was efficiently formed on the first main surface and the end surfaces simultaneously by a vacuum vapor deposition method.

Next, the heating vessel in which the antifouling layer formation composition had been placed was heated to 270° C. After the vessel temperature reached 270° C., the heating vessel was kept for 10 minutes until the temperature was stabilized. Next, the glass plate attached to the carrier substrate was placed in a vacuum chamber. After that, the antifouling layer formation composition was fed toward the outermost surface of the first main surface of the glass plate through a nozzle connected to the heating vessel in which the antifouling layer formation composition had been put. Thus, film formation was performed.

The film formation was performed while the film thickness thereof was measured by a crystal resonator monitor placed in the vacuum chamber until the film thickness of the antifouling layer reached 4 nm. Subsequently, the glass plate was pulled out from the vacuum chamber, placed on a hot plate with the fluorine-containing organic silicon compound film surface upward, and heat treatment was performed thereon in the atmosphere at 150° C. for 60 minutes.

In this manner, a glass plate in which the antireflection layer and the antifouling layer were provided on the first main surface of the glass plate was obtained.

### (7) Removal of the Antireflection Layer and the Antifouling Layer by Laser

For a laser oscillator for removing the antifouling layer from the first main surface of the glass plate, a CO₂ laser oscillator having a maximum output power of 1,500 W was used. A spot diameter of the laser was set at 3 mm and the output power was set at 70 W. In the antireflection layer and the antifouling layer on the first main surface of the glass plate, a place having a printing portion on the back surface was continuously irradiated. Thus, the antifouling layer was removed from a circular part having a diameter of about 30 mm to form an opening portion.

In this manner, a glass article having an opening portion was obtained.

### (8) Attachment of Member

By use of an epoxy-based adhesive, a button made of resin was bonded to the part of the glass plate from which the antifouling layer had been removed (the opening) in the glass article.

### Example 2

The same procedure as in Example 1 was used to obtain a glass article except that the output power of the laser was set at 90 W.

### Example 3

The same procedure as in Example 1 was used to obtain a glass article except that the output power of the laser was set at 500 W.

### Example 4

The same procedure as in Example 1 was used to obtain a glass article except that the output power of the laser was set at 1 W.

### Example 5

The same procedure as in Example 1 was used to obtain a glass article except that the laser was replaced by vacuum ultraviolet light.

### Example 6

The same procedure as in Example 1 was used to obtain a glass article except that the laser was replaced by a cutter.

### Example 7

The same procedure as in Example 1 was used to obtain a glass article except that the output power of the laser was set at 30 W and only the antifouling layer was formed.

### Example 8

The same procedure as in Example 1 was used to obtain a glass article, except that a YAG laser oscillator (Hybrid Laser Marker MD-T 1010W, made by Keyence Corporation) with a wavelength of 532 nm was used as a laser oscillator for removing an antifouling layer.

The output power of the YAG laser oscillator was set at 60% of its maximum output power of 4 W, and the scanning speed was set at 400 mm/sec.

### Example 9

The same procedure as in Example 8 was used to obtain a glass article, except that the scanning speed was set at 600 mm/sec.

### Example 10

The same procedure as in Example 8 was used to obtain a glass article, except that the scanning speed was set at 800 mm/sec.

### (Water Contact Angle)

After the laser irradiation, a water contact angle was measured in order to check whether the antireflection layer and the antifouling layer had been removed or not. A water droplet of about 1 μL was attached to the laser irradiated surface of the glass plate with the antireflection layer and the antifouling layer. A contact angle to water was measured by using a contact angle gauge (model: DM-51, made by Kyowa Interface Science Co., LTD.).
A: The water contact angle was smaller than 60°. Both the antireflection layer and the antifouling layer were removed.
B: The water contact angle was 60° to 100°. The antireflection layer remained.
C: The water contact angle was 100° to 130°. The antifouling layer remained.
   (Surface Roughness and Ten-Point Average Roughness in Opening Portion) The surface roughness and the ten-point average roughness in the opening portion of each glass article were measured. Each glass article obtained above was sectionally cut and polished by a focused ion beam processing and observation device (device name: SIINT-SMI3200SE, made by Seiko Instruments Inc.). A tissue of the section which had been polished was observed by an FE-SEM (product name: S4800, made by Hitachi, Ltd.) with 2 kV of accelerating voltage, and an SEM image was obtained.

A region from the first main surface of the glass plate to an FIB processing protective film (platinum) in a normal direction was regarded as a film deposition portion, and the thickness of the region was regarded as the thickness of the film deposition portion. The thickness was measured with respect to a horizontal direction of the glass plate, and a thickness distribution was obtained. The measurement was performed with a reference length of 2,500 nm, a measuring interval of 20 nm, and a measuring error of 2 nm. The surface roughness Ra and the ten-point average roughness Rz were calculated using the following Expressions 1 and 2.

$$\begin{matrix}Ra = \frac{1}{L} {\int }_{0}^{L} \vert f ( X ) \vert dX & Expression 1 \\ Rz = \frac{\begin{matrix}\vert Yp 1 + Yp 2 + Yp 3 + Yp 4 + Yp 5 \vert + \\ \vert Yv 1 + Yv 2 + Yv 3 + Yv 4 + Yv 5 \vert\end{matrix}}{5} & Expression 2\end{matrix}$$

### (Measurement of Fluorine Content)

Intensity of characteristic X-rays derived from an F element in the opening portion 13 was measured by an X-ray fluorescence analyzer (trade name: ZSX100e, made by Rigaku Corporation). Analysis was performed on the opening portion 13 masked with a mask having a diameter of 20 mm under conditions shown in Table 1, and Kα ray intensity derived from the F element was obtained.

TABLE 1

| measurement line | | F-Kα |
|---|---|---|
| target | | Rh |
| kV-mA | | 50-72 |
| filter | | OUT |
| attenuator | | 1/1 |
| slit | | Std |
| crystal | | RX35 |
| detector | | PC |
| PHA | | 130-350 |
| 2θ angle | peak | 38.808 |
| ↑ | B.G.1 | 36 |
| ↑ | B.G.2 | 42 |
| measurement time (s) | peak | 60 |
| ↑ | B.G.1 | 30 |
| ↑ | B.G.2 | 30 |

### (Member Adhesiveness)

After a member was attached to the glass article, the glass article was put into a chamber cycle. Each cycle was performed at 40±2° C. for 0.5 hours and at 95±2° C. for 0.5 hours. 100 cycles were performed. After that, whether the member was come off from the glass plate or not was checked visually.

A: The member was not come off from the glass plate.
B: The member was come off from the glass plate.

### (Adhesive Strength Test)

A metal jig (diameter 20 mm) made of aluminum was attached to the opening portion of each glass article by an adhesive agent (trade name: Hamatite SS-310, made by Yokohama Rubber Co., Ltd.). The jig adhered to the opening after 20 hours had passed since the jig was attached. The jig was pulled at a pulling rate of 0.2 MPa/sec by a testing device (product name: PosiTest AT-A, made by DeFelsko Corporation), and the adhesive strength was measured. Values of adhesive strength thus measured are shown in Table 2.

Table 2 shows results of evaluation in Examples 1 to 10.

TABLE 2

| | Example 1 | Example 2 | Example 3 | Example 4 | Example 5 |
|---|---|---|---|---|---|
| film | antireflection | antireflection | antireflection | antireflection | antireflection |
| configuration | layer and | layer and | layer and | layer and | layer and |
| | antifouling | antifouling | antifouling | antifouling | antifouling |
| | layer | layer | layer | layer | layer |
| film removing | CO₂ laser | CO₂ laser | CO₂ laser | CO₂ laser | vacuum |
| means | | | | | ultraviolet light |
| | | | | | (Xe excimer lamp) |
| output power | 70 | 90 | 500 | 1 | — |
| (W) of laser | | | | | |
| device | | | | | |
| removed | antireflection | antireflection | antireflection | antifouling | antifouling |
| layer | layer and | layer and | layer and | layer removed | layer removed |
| | antifouling | antifouling | antifouling | but | but |
| | layer removed | layer removed | layer removed | antireflection | antireflection |
| | | | | layer remained | layer remained |
| member | A | A | A | A | B |
| adhesiveness | | | | | |
| adhesive | 0.95 | 0.96 | 0.95 | 0.96 | 0.8 |
| strength | | | | | |
| (MPa) | | | | | |
| water contact | 15 | 15 | 15 | 25 | 55 |
| angle (°) | | | | | |
| Ra (nm) | 7 | 8 | 12 | 5 | 2 |
| Rz (nm) | 35 | 40 | 60 | 20 | 15 |
| Kαray | 0.06 | 0.06 | 0.05 | 0.12 | 0.8 |
| intensity | | | | | |
| derived from | | | | | |
| F element | | | | | |
| (kcps) | | | | | |

| | Example 6 | Example 7 | Example 8 | Example 9 | Example 10 |
|---|---|---|---|---|---|
| film | antireflection | antifouling | antireflection | antireflection | antireflection |
| configuration | layer and | layer | layer and | layer and | layer and |
| | antifouling | | antifouling | antifouling | antifouling |
| | layer | | layer | layer | layer |
| film removing | cutter | CO₂ laser | YAG laser | YAG laser | YAG laser |
| means | | | | | |
| output power | — | 30 | 2.4 | 2.4 | 2.4 |
| (W) of laser | | | | | |
| device | | | | | |
| removed | antifouling | antifouling | antifouling | antifouling | antifouling |
| layer | layer remained | layer removed | layer removed | layer removed | layer removed |
| member | B | A | A | A | A |
| adhesiveness | | | | | |
| adhesive | 0.75 | 0.95 | 0.96 | 0.96 | 0.95 |
| strength | | | | | |
| (MPa) | | | | | |
| water contact | 110 | 15 | 85 | 90 | 100 |
| angle (°) | | | | | |
| Ra (nm) | 1 | 6 | 7.74 | 7.07 | 4.66 |
| Rz (nm) | 10 | 22 | 49.6 | 37.7 | 19.84 |
| Kαray | 0.75 | 0.09 | 0.058 | 0.08 | 0.12 |
| intensity | | | | | |
| derived from | | | | | |
| F element | | | | | |
| (kcps) | | | | | |

As shown in Table 2, in Examples 1 to 4 and 7 to 10, the films could be removed with no bad appearance, and the member was not come off after the member was bonded to the part from which the films had been removed. In Example 5, the antifouling layer could be removed but the antireflection layer was remained, and the member was come off after the member was bonded. In Example 6, the antifouling layer was remained, and the member was come off after the member was bonded.

The present application is based on Japanese Patent Application No. 2016-180541 filed Sep. 15, 2016 and Japanese Patent Application No. 2017-158181 filed Aug. 18, 2017, and the contents of which are incorporated herein by reference.

1 . . . glass plate, 2 . . . first main surface, 3 . . . second main surface, 4 . . . end surface, 5 . . . antifouling layer, 6 . . . antireflection layer, 7 . . . printing layer, 8 . . . laser beam, 9 . . . glass article, 10 . . . member, 11 . . . glass article having a member, 12 . . . glass article, 13 . . . opening portion

What is claimed is:

1. A method for manufacturing a glass article, the glass article comprising:
a glass plate having a first main surface and a second main surface opposed to each other, and
an antifouling layer formed on the first main surface,
the method comprising:
irradiating the glass article with a laser beam from the first main surface side, thereby selectively removing the antifouling layer.

2. The method for manufacturing a glass article according to claim 1, wherein a laser device for oscillating the laser beam is a CO₂ laser device, YVO₄ laser device or a YAG laser device.

3. The method for manufacturing a glass article according to claim 1, wherein output power of the laser device is 1 to 1,000 W.

4. The method for manufacturing a glass article according to claim 1, wherein an antireflection layer is further formed between the first main surface of the glass plate and the antifouling layer.

5. A method for manufacturing a glass article having a member, the glass article comprising:
a glass plate having a first main surface and a second main surface opposed to each other, and
an antifouling layer formed on the first main surface,
the method comprising:
irradiating the glass article with a laser beam from the first main surface side, thereby selectively removing the antifouling layer, followed by bonding the member to a region from which the antifouling layer has been removed.

6. The method for manufacturing a glass article having a member according to claim 5, wherein an antireflection layer is further formed between the first main surface of the glass plate and the antifouling layer.

7. The method for manufacturing a glass article having a member according to claim 5, wherein the member comprises at least one of a resin, a metal and a rubber.

8. A glass article comprising:
a glass plate having a first main surface and a second main surface opposed to each other,
an antifouling portion which is formed on the first main surface and comprises an antifouling layer and
an opening portion which is formed on the first main surface, has no antifouling layer and has fine concave convex shapes.

9. The glass article according to claim 8, wherein a surface roughness Ra in the opening portion is 5 nm or higher.

10. The glass article according to claim 8, wherein a ten-point average roughness Rz in the opening portion is 17 nm or higher.

11. The glass article according to claim 8, wherein Kat characteristic X-ray intensity derived from a fluorine (F) element obtained by X-ray fluorescence analysis is 0.15 kcps or lower.

12. The glass article according to claim 8, wherein:
a printed layer is provided on a peripheral edge portion of the second main surface of the glass plate; and
the opening portion is formed on the first main surface within a region corresponding to a region on the second main surface where the printed layer is present.

13. The glass article according to claim 8, wherein an antireflection layer is provided between the first main surface of the glass plate and the antifouling layer in the antifouling portion.

14. The glass article according to claim 8, wherein a water contact angle of the opening portion is 105° or lower.
